(19) United States
(12) Patent Application Publication
(10) Pub. No.: US 2023/0223559 A1
(43) Pub. Date: Jul. 13, 2023

(54) LAYER SYSTEM, FLOW FIELD PLATE HAVING A LAYER SYSTEM OF THIS TYPE, AND FUEL CELL, ELECTROLYZER OR REDOX FLOW CELL

(71) Applicant: Schaeffler Technologies AG & Co. KG, Herzogenaurach (DE)

(72) Inventors: Moritz Wegener, Erlangen (DE); Nazlim Bagcivan, Nürnberg (DE); Edgar Schulz, Langensendelbach (DE); Ladislaus Dobrenizki, Höchstadt (DE); Jan Martin Stumpf, Erlangen (DE); Romina Baechstaedt, Wooster, OH (US); Jeevanthi Vivekananthan, Krefeld (DE)

(73) Assignee: Schaeffler Technologies AG & Co. KG, Herzogenaurach (DE)

(21) Appl. No.: 17/923,035

(22) PCT Filed: Apr. 16, 2021
(86) PCT No.: PCT/DE2021/100347

§ 371 Date: Feb. 16, 2023

(30) Foreign Application Priority Data
May 6, 2020 (DE) 10 2020 112 252.7

(51) Int. Cl. H01M 8/0228; H01M 8/0206; H01M 8/1065; H01M 8/0208

(52) U.S. Cl. CPC H01M 8/0228; H01M 8/0206; H01M 8/1065; H01M 8/0208; H01M 2008/1095

(57) ABSTRACT

A layer system for coating a metal substrate in order to form a flow field plate includes at least one cover layer made of metal oxide; at least one intermediate layer, which supports the cover layer; and a lower layer, which supports the intermediate layer(s). The cover layer is formed of indium tin oxide; wherein the indium tin oxide is optionally doped with at least one element from the group comprising carbon, nitrogen, boron, fluorine, hydrogen, silicon, titanium, tin and zirconium. At least one intermediate layer is formed of titanium nitride and/or titanium carbide and/or titanium carbonitride and/or titanium niobium nitride and/or titanium niobium carbide and/or titanium niobium carbonitride and/or chromium nitride and/or chromium carbide and/or chromium carbonitride. The lower layer is formed of titanium or a titanium-niobium alloy or chromium.

### CROSS-REFERENCE TO RELATED APPLICATIONS

This application is the U.S. National Phase of PCT Appln. No. PCT/DE2021/100347 filed Apr. 16, 2021, which claims priority to DE 10 2020 112 252.7 filed May 6, 2020, the entire disclosures of which are incorporated by reference herein.

### TECHNICAL FIELD

The disclosure relates to a layer system for coating a metal substrate to form a flow field plate, comprising at least one cover layer made of metal oxide. The disclosure further relates to a flow field plate comprising a metal substrate and such a layer system. Furthermore, the disclosure relates to a fuel cell, an electrolyzer or a redox flow cell comprising at least one such flow field plate.

### BACKGROUND

A flow field plate for a fuel cell or an electrolyzer is already known from DE 100 58 337 A1, in which a conductive and corrosion-resistant protective coating made of a metal oxide is formed on at least one side of a metal sheet. The metal oxide is formed in particular from an oxide of the elements or alloys from the group comprising tin, zinc and indium.

US 2018/0053948 A1 describes a separator for a polymer electrolyte fuel cell. The separator made of ferritic stainless steel has an indium tin oxide coating.

### SUMMARY

It is the object of the disclosure to provide an improved layer system for a flow field plate and to provide such a flow field plate. Furthermore, it is the object of the disclosure to propose a fuel cell, an electrolyzer or a redox flow cell with at least one such flow field plate.

The object is achieved for the layer system for coating a metal substrate to form a flow field plate, the layer system comprising at least one cover layer made of metal oxide, at least one intermediate layer supporting the cover layer and a lower layer supporting the intermediate layer(s) is formed, the cover layer being formed from indium tin oxide (ITO), wherein the indium tin oxide is optionally doped with at least one element from the group comprising carbon, nitrogen, boron, fluorine, hydrogen, silicon, titanium, tin and zirconium, wherein the at least one intermediate layer is formed from titanium nitride and/or titanium carbide and/or titanium carbonitride and/or titanium niobium nitride (TiNbN) and/or titanium niobium carbide (TiNbC) and/or titanium niobium carbonitride (TiNbCN) and/or chromium nitride (CrN) and/or chromium carbide (CrC) and/or chromium carbonitride (CrCN), and wherein the lower layer is formed from titanium (Ti) or a titanium-niobium alloy (TiNb) or chromium (Cr).

The layer system is characterized by high long-term stability with simultaneously high electrical conductivity and low cost, and without precious metal. In addition, the layer system ensures excellent corrosion protection for a metal base material or substrate of a flow field plate.

The layer system is preferably made by a PVD or a CVD process (PVD: physical vapor deposition; CVD: chemical vapor deposition).

Cover layers made of indium tin oxide which have an indium content in the range from 70 to 90 vol % are particularly preferred here. Particular preference is given to indium content in the range from 75 to 85 vol %, which has high electrical conductivity.

The lower layer is used in particular as an adhesion promoter between a metal substrate and the at least one intermediate layer. Furthermore, the lower layer forms conductive oxides and thus provides galvanic corrosion protection for the metal substrate of a flow field plate. The lower layer preferably has a layer thickness in the range from 1 nm to 300 nm.

In particular, the intermediate layer is also used as an adhesion promoter between the lower layer and the cover layer. Furthermore, the at least one intermediate layer also forms conductive oxides and thus provides galvanic corrosion protection for the lower layer and the metal substrate of a flow field plate. The at least one intermediate layer also provides a barrier for hydrogen, so that it cannot penetrate in the direction of the metal substrate and damage it. A layer thickness of an individual intermediate layer is preferably selected in the range from 0.1 to 3.0 μm. However, there can be two or more intermediate layers.

The cover layer protects the lower layer and the intermediate layer(s) mechanically and from corrosive attack. The cover layer in particular has a layer thickness in the range from 0.01 to 15 μm, in particular in the range from 0.1 to 3 μm.

The layer system according to the disclosure, comprising the lower layer, at least one intermediate layer and the cover layer, preferably has a total thickness in the range from 0.1 to 20 μm.

Furthermore, it has proven useful if the cover layer is doped with at least one element from the group comprising carbon, nitrogen, boron, fluorine, hydrogen, silicon, titanium, tin, and zirconium of at most 35 at %, in particular in the range from 0.1 to 10 at %, particularly preferably in the range from 1 to 5 at %. In this case, the doping element or the doping elements are incorporated in the oxide crystal lattice of the indium tin oxide.

In this case, the doping can be present uniformly over the layer thickness of the cover layer. Alternatively, the amount of doping element(s) can increase in the direction of a free surface of the cover layer, such that a gradient layer is formed. A doping element or a plurality of doping elements can also be present in a manner implanted only in the free surface of the cover layer.

Doping the cover layer with carbon and/or silicon is particularly preferred. In particular, hydrogen is only present in traces in the cover layer.

In particular, the following layer systems for coating a metal substrate, preferably made of steel, in particular austenitic steel or austenitic stainless steel, have proven to be advantageous for forming a flow field plate:

### Example 1

| | |
|---|---|
| Lower layer: TiNb or Ti | Layer thickness: 100 nm |
| Intermediate layer: TiNbN | Layer thickness: 300 nm |
| Cover layer: Indium tin oxide with | Layer thickness: 100 nm |
| 80 vol % indium content | |

### Example 2

| | |
|---|---|
| Lower layer: TiNb or Ti | Layer thickness: 100 nm |
| Intermediate layer: TiNbCN | Layer thickness: 300 nm |
| Cover layer: Indium tin oxide with | Layer thickness: 100 nm |
| 80 vol % indium content | |

### Example 3

| | |
|---|---|
| Lower layer: TiNb or Ti | Layer thickness: 100 nm |
| 1. Intermediate layer: TiNbN | Layer thickness: 200 nm |
| 2. Intermediate layer: TiNbCN | Layer thickness: 200 nm |
| Cover layer: Indium tin oxide with | Layer thickness: 100 nm |
| 90 vol % indium content | |

### Example 4

| | |
|---|---|
| Lower layer: TiNb or Ti | Layer thickness: 100 nm |
| 1. Intermediate layer: TiNbCN | Layer thickness: 200 nm |
| 2. Intermediate layer: TiNbN | Layer thickness: 200 nm |
| Cover layer: Indium tin oxide with | Layer thickness: 100 nm |
| 80 vol % indium content | |

### Example 5

| | |
|---|---|
| Lower layer: TiNb or Ti | Layer thickness: 100 nm |
| Intermediate layer: TiN | Layer thickness: 300 nm |
| Cover layer: Indium tin oxide with | Layer thickness: 100 nm |
| 80 vol % indium content | |

### Example 6

| | |
|---|---|
| Lower layer: TiNb or Ti | Layer thickness: 100 nm |
| Intermediate layer: TiC and/or TiNbC | Layer thickness: 300 nm |
| Cover layer: Indium tin oxide with | Layer thickness: 100 nm |
| 80 vol % indium content | |

### Example 7

| | |
|---|---|
| Lower layer: TiNb or Ti | Layer thickness: 100 nm |
| Intermediate layer: TiCN | Layer thickness: 300 nm |
| Cover layer: Indium tin oxide with | Layer thickness: 100 nm |
| 80 vol % indium content | |

### Example 8

| | |
|---|---|
| Lower layer: Cr | Layer thickness: 100 nm |
| Intermediate layer: CrN and/or CrCN | Layer thickness: 300 nm |
| Cover layer: Indium tin oxide with | Layer thickness: 100 nm |
| 80 vol % indium content | |

### Example 9

| | |
|---|---|
| Lower layer: Cr | Layer thickness: 100 nm |
| Intermediate layer: CrC and/or CrCN | Layer thickness: 300 nm |
| Cover layer: Indium tin oxide with | Layer thickness: 100 nm |
| 80 vol % indium content | |

The object is achieved for a flow field plate comprising a metal substrate and a layer system according to the disclosure with a structure of the flow field plate in the order:

metal substrate,
lower layer,
intermediate layer(s),
cover layer.

This is preferably a flow field plate with a metal substrate or a metal carrier plate, preferably made of steel, in particular made of austenitic steel or stainless steel. A carrier plate can be designed in one or more parts.

### BRIEF DESCRIPTION OF THE DRAWINGS

FIGS. 1 to 3 are intended to explain, by way of example, a layer system according to the disclosure, a flow field plate formed therewith and a fuel cell. In the figures:

FIG. 1 shows a flow field plate having the layer system;

FIG. 2 schematically shows a fuel cell system comprising a plurality of fuel cells;

FIG. 3 shows an enlarged view of a cross section through a layer system shown by way of example.

### DETAILED DESCRIPTION

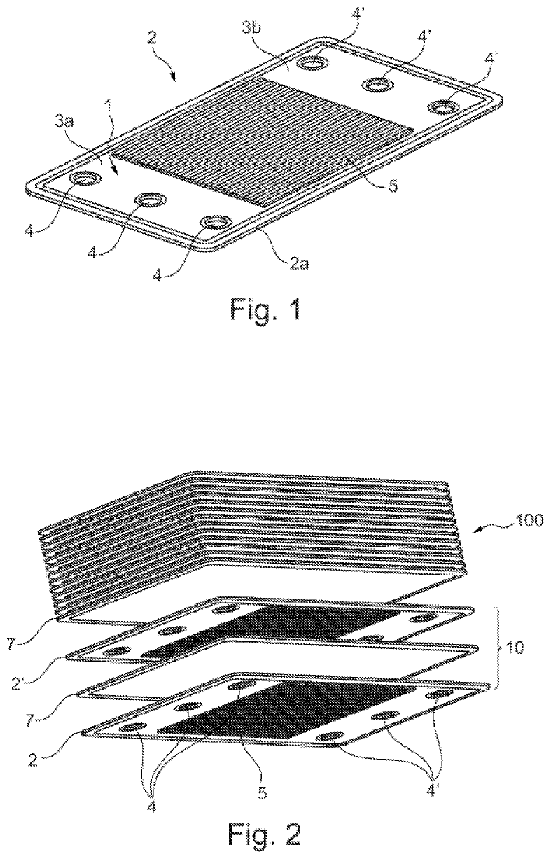

FIG. 1 shows a flow field plate 2 having a layer system 1, which here has a metal substrate 2a or a metal carrier plate made of austenitic steel. The flow field plate 2 has an inflow region 3a with openings 4 and an outlet region 3b with further openings 4′, which are used to supply a fuel cell with process gases and to remove reaction products from the fuel cell. The flow field plate 2 also has a gas distribution structure 5 on each side, which is provided for contact with a polymer electrolyte membrane 7 (see FIG. 2).

FIG. 2 schematically shows a fuel cell system 100 comprising a plurality of fuel cells 10. Each fuel cell 10 comprises a polymer electrolyte membrane 7 which is adjacent to both sides of the flow field plates 2, 2′. The same reference signs as in FIG. 1 indicate identical elements.

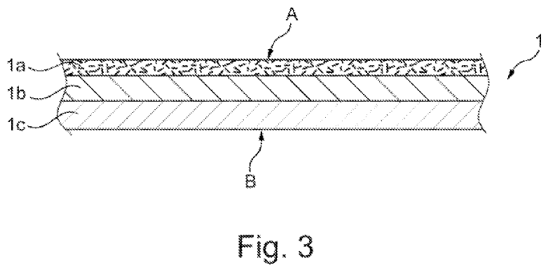

FIG. 3 shows a cross section through the layer system 1 according to FIG. 1. It can be seen that a cover layer 1a, an intermediate layer 1b and a lower layer 1c are present. The lower layer 1c is disposed on a side B of the layer system 1 which is arranged facing the substrate 2a of the flow field plate 2. The cover layer 1a is disposed on a side A of the layer system 1 which is arranged facing away from the substrate 2a of a flow field plate 2. Alternatively, the layer system 1 can also have a plurality of intermediate layers 1b.

### LIST OF REFERENCE SYMBOLS

1 Layer system
1a Cover layer
1b Intermediate layer(s)
1c Lower layer
2, 2′ Flow field plate
2a Metal substrate
3a Inflow region
3b Outlet region
4, 4′ Opening
5 Gas distribution structure
7 Polymer electrolyte membrane
10 Fuel cell
100 Fuel cell system
A Side of the layer system 1 facing away from the substrate 2a
B Side of the layer system 1 facing the substrate 2a

1. A layer system for coating a metal substrate to form a flow field plate, comprising:
at least one cover layer made of metal oxide, at least one intermediate layer supporting the cover layer and a lower layer supporting the intermediate layer,
wherein the cover layer is formed from indium tin oxide,
wherein the indium tin oxide is doped with at least one element from group comprising carbon, nitrogen, boron, fluorine, hydrogen, silicon, titanium, tin, and zirconium,
wherein the at least one intermediate layer is formed from titanium nitride or titanium carbide or titanium carbonitride or titanium niobium nitride or titanium niobium carbide or titanium niobium carbonitride or chromium nitride or chromium carbide or chromium carbonitride, and
wherein the lower layer is formed from titanium or a titanium-niobium alloy or chromium.

2. The layer system according to claim 1, wherein the cover layer made of indium tin oxide has an indium content in a range from 70 to 90 vol %.

3. The layer system according to claim 1, wherein the lower layer has a layer thickness in a range from 1 to 300 nm.

4. The layer system according to claim 1, wherein the at least one intermediate layer has a layer thickness in range from 0.1 μm to 3.0 μm.

5. The layer system according to claim 1, wherein the cover layer has a layer thickness in a range from 0.01 μm to 15 μm.

6. The layer system according to claim 1, wherein the cover layer is doped with at least one element from a group comprising carbon, nitrogen, boron, fluorine, hydrogen, silicon, titanium, tin and zirconium of at most 35 at %.

7. A flow field plate comprising a metal substrate and a layer system according to claim 1, having a structure of the flow field plate in the order:
metal substrate,
lower layer,
intermediate layer(s), and
cover layer.

8. The flow field plate according to claim 7, wherein the metal substrate is formed from steel.

9. A fuel cell, comprising at least one flow field plate according to claim 7.

10. The fuel cell according to claim 9, comprising at least one polymer electrolyte membrane.

11. The layer system according to claim 1, wherein the cover layer is doped with at least one element from a group comprising carbon, nitrogen, boron, fluorine, hydrogen, silicon, titanium, tin and zirconium in a range from 0.1 to 10 at %.

12. The fuel cell according to claim 9, wherein the fuel cell is an oxygen-hydrogen fuel cell or electrolyzer or redox flow cell.
